(19) United States
(12) Patent Application Publication
(10) Pub. No.: US 2008/0198470 A1
(43) Pub. Date: Aug. 21, 2008

(54) QUICK ADJUSTMENT EYECUP FOR OPTICAL VIEWING INSTRUMENTS

(76) Inventor: Samuel J. Hamilton, Mount Horeb, WI (US)

Correspondence Address: ST. ONGE STEWARD JOHNSTON & REENS, LLC, 986 BEDFORD STREET, STAMFORD, CT, 06905-5619, US

(21) Appl. No.: 11/677,341

(22) Filed: Feb. 21, 2007

(51) Int. Cl. G02B 23/16

(52) U.S. Cl. 359/600; 359/611

(57) ABSTRACT

An optical viewing instrument is disclosed generally comprising an eyecup with a cylindrical surface and a housing with an ocular lens portion that has a corresponding cylindrical surface for slidably receiving the eyecup. The ocular lens portion has bearings protruding therefrom, and the eyecup includes longitudinal channels for receiving the bearings as the housing receives the eyecup and curvilinear channels for accommodating the bearings as the eyecup is rotated. In certain embodiments, the ocular lens portion also includes a detent, and the eyecup has a plurality of grooves into which the detent clicks as the eyecup is rotated. In some embodiments, the curvilinear channels are spiral shaped to cause axial motion of the eyecup when rotated.

### FIELD OF THE INVENTION

The present invention relates to a versatile eyecup for optical viewing instruments, such as binoculars and spotting scopes. More specifically, the invention relates to a optical viewing instrument with an eyecup that can be quickly moved into many different positions and interchanged with other eyecups.

### BACKGROUND OF THE INVENTION

Optical viewing devices, such as binoculars, are generally well known in the art. These devices typically include a main body, essentially comprised of a pair of lens barrels, where each barrel includes an objective lens at one end, where light enters the viewing instrument, and an ocular lens at the other end, through which the user looks to see the image.

In order for a user to properly see the image through the ocular lens end of a viewing instrument, the user must place his or her eye some distance behind the ocular lens, as placing it directly on the lens itself would, of course, be quite uncomfortable. Additionally, some distance is often always required, irrespective of the discomfort of placing the eye directly on the lens, due to the fact that some users wear eyeglasses.

As a result, viewing instruments employ devices for creating what is typically referred to as “eye relief,” which is the distance behind the ocular lens that a user must place his or her eye in order to see the full field of view through the optical instrument. This eye relief is illustrated in FIG. 2B, and is more precisely defined as the distance from the iris of the user's eye to the location of the lens that is closest to the eye.

However, the resultant air space between the ocular lens and the user's eye can present a couple of problems. First, the lack of direct contact between the user's eye and the viewing instrument can make it difficult to view a steady image through the instrument. For example, with a spotting scope, the user's head may make slight movements, which can make it difficult to keep the beam of light exiting the instrument continuously entering the pupil of the eye. In the case of binoculars, the user must not only contend with the challenge of holding his or her head perfectly still, but must also try to hold the binoculars steady in his or her hands. Second, because of the airspace between the ocular lens and the user's eye, stray light can easily enter into the user's peripheral vision, thereby creating glare, and thus, degrading the visible image.

Accordingly, in order to counteract these problems associated with the space resulting from necessary eye relief, it has become somewhat customary to attach an eyecup to the ocular end of the viewing instrument. This device generally comprises a cylinder coupled to the ocular end of the lens barrel, and is cut to the appropriate length to match the eye relief of the viewing instrument. This allows the user to place his or her eye in contact with the opening of the eye-cup and view through it into the ocular lens. Therefore, the attachment of the eyecup results in several advantages, including providing some stability for the user's head relative to the viewing instrument, as well as helping to block out stray light.

However, such eyecups can present problems for many users—namely, those who need to wear eyeglasses while looking through the instrument. Since the eyeglass lenses sit directly in front of the user's eyes, they limit how close the eyeglass-wearing user can position his or her eye to the eye-cup opening, as shown in FIG. 2B. In effect, the user's eye is pushed further away from the ocular lens, and therefore, results in an inappropriate eye relief distance.

One solution that was employed to deal with this problem was to make the eye-cup out of rubber. By doing so, an eyeglass user could fold the eyecup down in order to position their eye closer to the ocular lens. Another benefit of using rubber was that, since the eye-cup is in direct contact with the user's eyeglasses, the user's eyeglasses would not get scratched. However, it was realized that the rubber eyecup was also not without its problems. One major problem of the rubber eyecup design is that, after repeated folding and unfolding of the eyecup, the rubber will weaken and eventually tear.

Accordingly, in order to improve upon this flaw, a new eyecup design was proposed. Instead of using an eyecup comprising a rubber cylinder that could be folded and unfolded, the eyecup was instead fashioned from two pieces: a rigid cylinder and a rubber “cushion” on the end of the rigid cylinder, adjacent the user's eye. This rigid cylinder was machined with helical or spiral tracks along its walls, and pins, fixed adjacent to the ocular lens on the optical instrument, would ride in these helical or spiral tracks in order to allow the cylinder to be twisted up or down. An example of such a design is described in U.S. Pat. No. 6,580,555 to Christa and is illustrated in FIG. 3B. This type of eyecup design has proven to be more robust in the sense that its parts are much more wear resistant, and it is also more convenient because the user can simply twist the eye-cup away from the lens barrel for use without eyeglasses or twist it towards the lens barrel when using the instrument while wearing glasses.

However, one problem with these devices that use a cam to translate the rotation of the eyecup into axial motion is that the positioning of the eyecup is not secure. Because the eyecup is repeatedly being moved into contact with the eye and the user is typically leaning his her face into the eyecup, forces are constantly being applied thereto. As a result, the forces applied unintentionally by the user can cause the pin to move slightly within the curved track. This can result in an inappropriate eye relief distance, can cause a pair of eye pieces to not maintain a parallel alignment, and can even cause the axis of the eyecup to tilt away from the axis of the ocular lens.

Accordingly, it has been suggested to use an eyecup employing a cam track that has secured positions, such as that disclosed in the '555 patent and illustrated in FIG. 3A. In this type of design, the end of the cam track proximal to the user's eye obviously serves as a secure stop against any forces applied by the user toward the ocular lens, and the other end of the cam track turns perpendicular to the rest of the track (forming an L-shape), likewise preventing any movement of the eyecup in the direction of the ocular lens when the pin is positioned at this distal end of the channel.

Unfortunately, this design likewise suffers from a lack of versatility, stemming from the fact that this eyecup has only two secure positions: eye-cup all the way down, and eye-cup all the way up. However, not every user that wears eyeglasses has lenses that are the exact same distance away from the user's eyes. This means that, for some users who wear eyeglasses, when the eye-cup is twisted all the way down, their eye may be slightly in front of, or behind, the desired eye relief distance. While some manufacturers have attempted to accommodate varying eyeglass lens distances by increasing the eye relief distance more and more in order to compensate for users who still can't seem to position their eyes close enough to the ocular lens while wearing eyeglasses, this is at the expense of other users whose eyes work better with a smaller eye relief distance.

Accordingly, it has been suggested to use an eyecup employing an irregularly shaped track so as to create a few “steps” along the length of the track, such as that disclosed in U.S. Patent Application No. 2005/0024740 by Smithbaker et al. and illustrated in FIG. 3C. Using this type of design, multiple stops are created, thereby providing several secure positions in the direction of axial motion. This, too, is limited in terms of ability to be truly versatile, as this design still employs a very limited number of secure positions. Further, this design still suffers from the same problem that all the above eyecup designs fail to fully correct-namely, that stray light can still leak in through the outer edge of the eyecup.

What is desired, therefore, is an optical viewing instrument that is versatile enough to adequately accommodate the needs of the many different users that may use them. What is further desired is an optical viewing instrument that enables many users to adequately adjust the eye relief to a distance appropriate for that user. What is also desired is an optical viewing instrument that better achieves the elimination of stray light from entering a user's peripheral vision.

### SUMMARY OF THE INVENTION

Accordingly, it is an object of the present invention to provide an optical viewing instrument that easily translates rotational motion of an eyecup into axial motion of the eyecup.

It is a further object of the present invention to provide an optical viewing instrument that has many secure positions to prevent undesired movement.

It is yet another object of the present invention to provide an optical viewing instrument that employs eyecups that can be easily interchanged depending on whether the user wears eyeglasses.

It is still another object of the present invention to provide an optical viewing instrument that is relatively simple and inexpensive to manufacture.

In order to overcome the deficiencies of the prior art and to achieve at least some of the objects and advantages listed, the invention comprises an optical viewing instrument, including an eyecup having a first substantially cylindrical surface, and a housing having an ocular lens portion that slidably receives the eyecup, the ocular lens portion having a second substantially cylindrical surface that engages the first substantially cylindrical surface, wherein one of the first and second surfaces includes a bearing protruding therefrom, and the other of the surfaces includes a longitudinal channel that receives the bearing as the ocular lens portion slidably receives the eyecup, and a curvilinear channel in which the bearing slides as the eyecup is rotated relative to the ocular lens portion.

In another embodiment, the invention comprises an optical viewing instrument, including an eyecup having a first substantially cylindrical surface, and a housing having an ocular lens portion that slidably receives the eyecup, the ocular lens portion having a second substantially cylindrical surface that engages the first substantially cylindrical surface, wherein one of the first and second surfaces includes a detent protruding therefrom, and the other of the surfaces includes a plurality of grooves into which the detent clicks as the eyecup is rotated relative to the ocular lens portion.

In some embodiments, the longitudinal channel includes a ridge for retaining the bearing in the channel. In some embodiments, the curvilinear channel comprises a spiral channel, such that the eyecup moves axially as the eyecup is rotated relative to the ocular lens portion.

In certain embodiments, the first and second surfaces include a second bearing and a second curvilinear channel in which the second bearing slides. In some of these embodiments, the first and second bearings comprise ball bearings with a diameter of approximately 2 mm.

In some embodiments, the detent is in a first position when clicked into a first of the grooves, and the detent is in a second position approximately 1 mm from the first position when the detent is clicked into a second of the grooves adjacent the first groove. In certain embodiments, the detent is spring loaded, and in some cases, the detent comprises a ball bearing with a diameter of approximately 1 mm.

In some embodiments, the ocular lens portion has an outer surface comprising the second surface and including the bearing, and the eyecup has an inner surface comprising the first surface and including the longitudinal and curvilinear channels.

In certain of these embodiments, the invention further includes a second eyecup having an inner, substantially cylindrical surface that engages the second substantially cylindrical surface, the inner surface of the second eyecup having a longitudinal channel that receives the bearing as the ocular lens portion slidably receives the second eyecup, and a curvilinear channel in which the bearing slides as the second eyecup is rotated relative to the ocular lens portion, wherein the second eyecup includes a side shield for blocking stray light. In some of these cases, the curvilinear channel of the second eyecup extends substantially perpendicular to a longitudinal axis of the second eyecup. In certain of these embodiments, the curvilinear channel extends approximately sixty degrees around the longitudinal axis of the second eyecup.

In some embodiments, the eyecup includes a rigid portion including the first substantially cylindrical surface that engages the second substantially cylindrical surface, and a rubber cushion mounted to the rigid portion.

In yet another embodiment, the invention comprises an optical viewing instrument, including a housing having an objective end and an ocular end, the ocular end having a left ocular lens portion and a right ocular lens portion, a plurality of left eyecups slidable onto the left ocular lens portion, and a plurality of right eyecups slidable onto the right ocular lens portion, wherein each of the left and right ocular lens portions includes a bearing protruding therefrom, wherein each of the left eyecups includes a longitudinal channel that receives the bearing protruding from the left ocular portion as the left eyecups are slid onto the left ocular portion and a curvilinear channel in which the bearing protruding from the left ocular portion slides as the left eyecups are rotated relative to the left ocular lens portion, and wherein each of the right eyecups includes a longitudinal channel that receives the bearing protruding from the right ocular portion as the right eyecups are slid onto the right ocular portion and a curvilinear channel in which the bearing protruding from the right ocular portion slides as the right eyecups are rotated relative to the right ocular lens portion.

In some of these embodiments, at least one of the left eyecups and at least one of the right eyecups has a side shield for blocking stray light, and at least one of the left eyecups and at least one of the right eyecups does not have a side shield.

### BRIEF DESCRIPTION OF THE DRAWINGS

FIG. 1 is a perspective view of a pair of binoculars in accordance with the invention.

FIG. 2A is a side view of the binoculars of FIG. 1 with the eyecup extended.

FIG. 2B is a side view of the binoculars of FIG. 1 with the eyecup not-extended.

FIGS. 3A-C are perspective views of eyecups known in the prior art.

FIG. 4A is a perspective view of the eyecup and ocular lens portion of the instrument of FIG. 1.

FIGS. 4B-C are perspective views of the eyecup of FIG. 4A.

FIGS. 5A-B are perspective views of an eyecup with side shield used with the instrument of FIG. 1.

### DETAILED DESCRIPTION OF THE INVENTION

The basic components of one embodiment of an optical viewing instrument in accordance with the invention are illustrated in FIG. 1. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

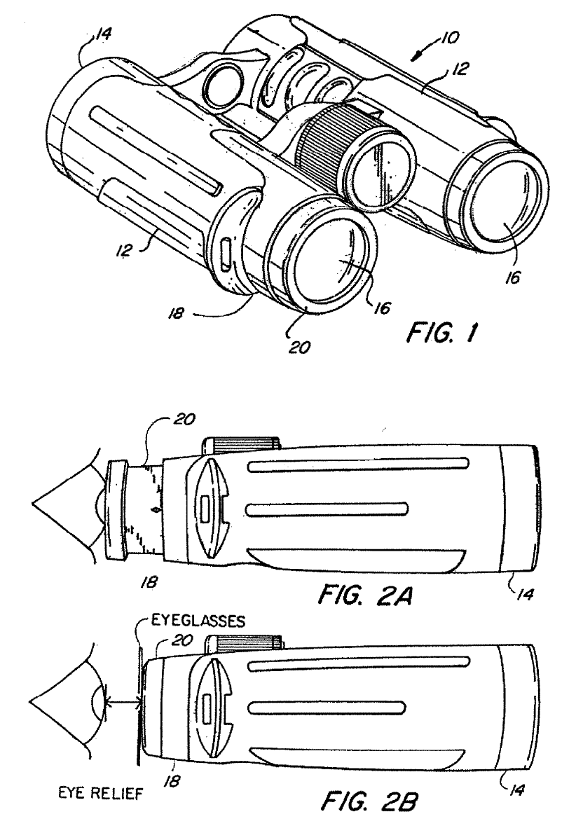

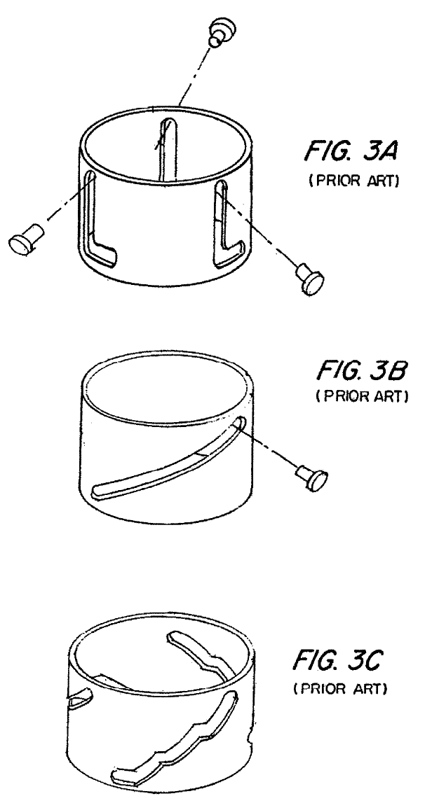

A pair of binoculars 10 includes two lens barrels 12, each of which has an objective lens (not shown) at a distal end 14 and an ocular lens 16 at a proximal end 18. Coupled to the proximal, ocular lens section 18 of each barrel 12 is an eyecup 20. As illustrated in FIGS. 2A-B, the eyecups 20 can each be moved axially to be positioned closer to or farther away from the ocular lens 16, thereby varying the eye relief distance.

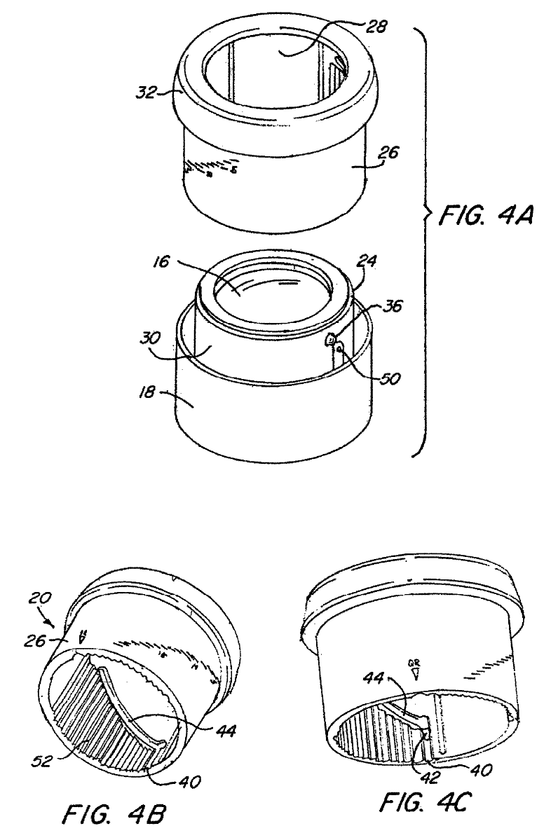

As shown in FIG. 4A, the proximal end 18 of the instrument 10 includes a cylindrical housing 24 that houses the ocular lens 16. The eyecup 20 includes a rigid cylinder 26, which has a substantially cylindrical inner surface 28 that engages the substantially cylindrical outer surface 30 of the housing 24. A rubber cushion 32 is mounted on the end of the rigid cylinder 26, such that the eyecup 20 can be positioned against the user's eye without any discomfort or against a user's eyeglasses without scratching same.

As also shown in FIG. 4A, the outer surface 30 of the housing 24 includes a bearing 36, which, in some advantageous embodiments, comprises an approximately 2 mm ball bearing. Turning to FIGS. 4B-C, the inner surface 28 of the eyecup 20 has a pair of channels 40, 44 therein for accommodating the bearing 36. A longitudinal channel 40 begins at the edge of the rigid cylinder 26 to receive the bearing 36 and extends longitudinally in order to accommodate the bearing 36 as the eyecup 20 is moved axially onto the cylindrical housing 24. The longitudinal channel 40 includes a ridge 42 for retaining the bearing 36 in the channel, thereby preventing axial motion in the reverse direction (to prevent the eyecup 20 from falling off the housing 24), unless a certain threshold force is applied.

A curvilinear channel 44 connects to the longitudinal channel 40 in order to accommodate the bearing 36 when the eyecup 20 is subsequently rotated. This channel 44 acts as a sort of “track” for the bearing 36, and, in certain advantageous embodiments, the curvilinear channel 44 has a spiral shape. As a result, as the eyecup 20 is rotated, the bearing 36 slides in the channel 44, forcing the eyecup 20 to advance longitudinally towards or away from (depending on the direction of rotation) the proximal end 18 of the instrument 10. In some embodiments, matching bearings 36 and curvilinear channels 44 (and longitudinal channels 40) are provided on opposite sides of the cylindrical inner surface 28. In this way, rotational motion of the eyecup 20 is easily translated into axial motion thereof.

The outer surface 30 of the cylindrical housing 24 also includes a detent 50, which, in certain advantageous embodiments, is spring-operated. In some embodiments, the detent 50 is a ball bearing. The inner surface 28 of the eyecup 20 includes a plurality of adjacent grooves 52, into which the detent 50 clicks as the eyecup 20 is rotated. In this way, multiple click-stop settings are created, which, in some embodiments, occur in increments of approximately 1 mm. Accordingly, the eyecup 20 is extremely versatile, as it allows users to customize the eyecup 20 according to their individual needs, and it allows a user, whether or not he or she wears eyeglasses, to establish an appropriate eye relief distance, which, for most eyeglass wearers, is generally accepted to be about 15-20 mm.

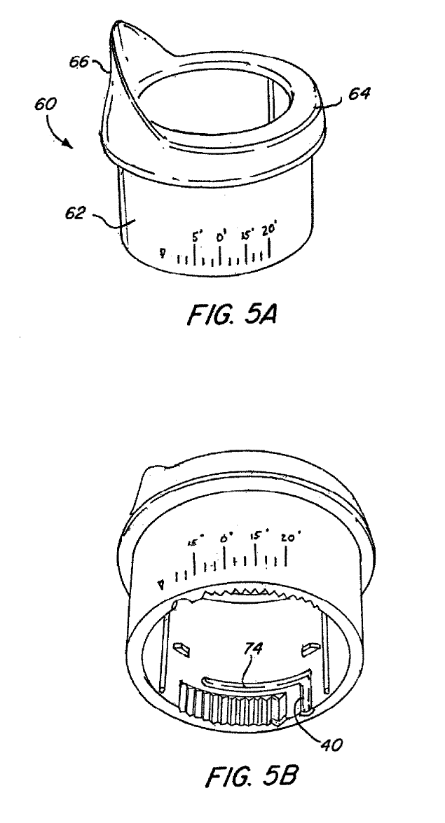

Because the longitudinal channels 40 and bearings 36 provide a quick release mechanism for the eyecup 20 (upon application of a slight force to overcome the ridge 42), eyecups can be easily interchanged. Accordingly, in certain advantageous embodiments, the instrument 10 is provided with a second eyecup 60, illustrated in FIGS. 5A-B. Like eyecup 20, eyecup 60 includes a rigid cylinder 62 and rubber cushion 64. However, as illustrated in FIG. 5A, the rubber cushion 64 includes a side shield 66 to block stray light and prevent it from entering the user's field of vision. Because the shield 66 causes the cushion 64 to be non-symmetrical, it would interfere with the lenses of eyeglasses worn by the user. Thus, while the side shield 66 can be of considerable benefit to a user who does not wear glasses, the eyecup 60 is typically not useful for eyeglass wearers. Accordingly, the quick-release mechanism described above facilitates the easy changing of eyecups as is appropriate.

As shown in FIG. 5B, the curvilinear channel 74 of the side shield eyecup 60 generally comprises a partially annular channel, rather than a spiral one. Because the eyecup 60 will tend to be used only by non-eyeglass wearers, moving the eyecup 60 closer to the proximal end 18 of the instrument 10 in order to compensate for the various extra eye relief distances caused by eyeglasses is not a concern. Accordingly, the non-spiral channel 74 is provided, allowing the user to rotate the eyecup 60 to obtain a precise position of the side shield 66 without moving the eyecup 60 axially. In certain advantageous embodiments, the channel 74 will extend approximately sixty degrees around the longitudinal axis of the eyecup 60 in order to adequately facilitate this adjustment.

These mechanisms provide maximum versatility, as they allow the eyecups to be easily and quickly interchanged with a slight pull and push of the eyecups in order to permit use of the most appropriate one for a particular user, and, further, provide for many different, easily-adjustable, secure positions depending on the particular eye relief distance required.

In certain advantageous embodiments, the bearings 36 are ball bearings with a diameter of approximately 2 mm, and the detent 50 is a ball bearing with a diameter of approximately 1 mm and positioned slightly below one of the larger bearings 36.

It should be noted that, while the above mechanisms have been described with respect to an eyecup 20 that fits over a cylindrical housing 24, a different arrangement may also be employed, such that an outer surface of the eyecup 20 engages an inner surface of a portion of the proximal end 18 of the instrument 20. Additionally, though the embodiment described and illustrated above has been described with reference to binoculars, it should be noted that present invention may be embodied in various types of optical viewing devices, including, but not limited to, spotting scopes, monoculars, field glasses, telescopes, and other types of focusing devices.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. An optical viewing instrument, comprising:
an eyecup having a first substantially cylindrical surface; and
a housing having an ocular lens portion that slidably receives said eyecup, said ocular lens portion having a second substantially cylindrical surface that engages said first substantially cylindrical surface;
wherein one of said first and second surfaces includes a bearing protruding therefrom, and the other of said surfaces includes a longitudinal channel that receives said bearing as said ocular lens portion slidably receives said eyecup, and a curvilinear channel in which said bearing slides as said eyecup is rotated relative to said ocular lens portion.

2. The viewing instrument of claim 1, wherein said longitudinal channel includes a ridge for retaining said bearing in said channel.

3. The viewing instrument of claim 1, wherein said first and second surfaces include a second bearing and a second curvilinear channel in which said second bearing slides.

4. The viewing instrument of claim 3, wherein said first and second bearings comprise ball bearings with a diameter of approximately 2 mm.

5. The viewing instrument of claim 1, wherein one of said first and second surfaces includes a detent protruding therefrom, and the other of said surfaces includes a plurality of grooves into which said detent clicks as said eyecup is rotated relative to said ocular lens portion.

6. The viewing instrument of claim 1, wherein said detent is in a first position when clicked into a first of said grooves, and said detent is in a second position approximately 1 mm from said first position when said detent is clicked into a second of said grooves adjacent said first groove.

7. The viewing instrument of claim 1, wherein said detent is spring loaded.

8. The viewing instrument of claim 1, wherein said detent comprises a ball bearing with a diameter of approximately 1 mm.

9. The viewing instrument of claim 1, wherein said curvilinear channel comprises a spiral channel, such that said eyecup moves axially as said eyecup is rotated relative to said ocular lens portion.

10. The viewing instrument of claim 1, wherein said ocular lens portion has an outer surface comprising said second surface and including said bearing, and said eyecup has an inner surface comprising said first surface and including said longitudinal and curvilinear channels.

11. The viewing instrument of claim 10, further comprising a second eyecup having an inner, substantially cylindrical surface that engages said second substantially cylindrical surface, the inner surface of said second eyecup having a longitudinal channel that receives said bearing as said ocular lens portion slidably receives said second eyecup, and a curvilinear channel in which said bearing slides as said second eyecup is rotated relative to said ocular lens portion, wherein said second eyecup includes a side shield for blocking stray light.

12. The viewing instrument of claim 11, wherein said curvilinear channel of said second eyecup extends substantially perpendicular to a longitudinal axis of said second eyecup.

13. The viewing instrument of claim 12, wherein said curvilinear channel extends approximately sixty degrees around the longitudinal axis of said second eyecup.

14. The viewing instrument of claim 1, wherein said eyecup comprises:
a rigid portion including said first substantially cylindrical surface that engages said second substantially cylindrical surface; and
a rubber cushion mounted to said rigid portion.

15. An optical viewing instrument, comprising:
an eyecup having a first substantially cylindrical surface; and
a housing having an ocular lens portion that slidably receives said eyecup, said ocular lens portion having a second substantially cylindrical surface that engages said first substantially cylindrical surface;
wherein one of said first and second surfaces includes a detent protruding therefrom, and the other of said surfaces includes a plurality of grooves into which said detent clicks as said eyecup is rotated relative to said ocular lens portion.

16. The viewing instrument of claim 15, wherein said detent is in a first position when clicked into a first of said grooves, and said detent is in a second position approximately 1 mm from said first position when said detent is clicked into a second of said grooves adjacent said first groove

17. The viewing instrument of claim 15, wherein said detent is spring loaded.

18. The viewing instrument of claim 15, wherein said detent comprises a ball bearing with a diameter of approximately 1 mm.

19. An optical viewing instrument, comprising:
a housing having an objective end and an ocular end, said ocular end having a left ocular lens portion and a right ocular lens portion;
a plurality of left eyecups slidable onto said left ocular lens portion; and
a plurality of right eyecups slidable onto said right ocular lens portion;
wherein each of said left and right ocular lens portions includes a bearing protruding therefrom;
wherein each of said left eyecups includes a longitudinal channel that receives the bearing protruding from said left ocular portion as said left eyecups are slid onto said left ocular portion and a curvilinear channel in which the bearing protruding from said left ocular portion slides as said left eyecups are rotated relative to said left ocular lens portion; and
wherein each of said right eyecups includes a longitudinal channel that receives the bearing protruding from said right ocular portion as said right eyecups are slid onto said right ocular portion and a curvilinear channel in which the bearing protruding from said right ocular portion slides as said right eyecups are rotated relative to said right ocular lens portion.

20. The viewing instrument of claim 19, wherein at least one of said left eyecups and at least one of said right eyecups has a side shield for blocking stray light, and at least one of said left eyecups and at least one of said right eyecups does not have a side shield.
